(19) United States
(12) Patent Application Publication
(10) Pub. No.: US 2021/0040787 A1
(43) Pub. Date: Feb. 11, 2021

(54) ELECTROMAGNETIC CLUTCH AND OPENING AND CLOSING BODY DRIVE DEVICE FOR VEHICLE

(71) Applicant: AISIN SEIKI KABUSHIKI KAISHA, Kariya-shi (JP)

(72) Inventor: Motohiko HIROSE, Kariya-shi (JP)

(73) Assignee: AISIN SEIKI KABUSHIKI KAISHA, Kariya-shi (JP)

(21) Appl. No.: 16/818,915

(22) Filed: Mar. 13, 2020

(30) Foreign Application Priority Data
Aug. 8, 2019 (JP) 2019-146747

(51) Int. Cl. E05F 15/627; F16D 27/04

(52) U.S. Cl. CPC E05F 15/627; F16D 27/04; E05Y 2201/216; F16D 2121/20; E05Y 2201/248; E05Y 2201/258; E05Y 2201/462; E05Y 2201/246

(57) ABSTRACT

An electromagnetic clutch includes: a rotation shaft that transmits a drive torque; a first rotation body that rotates integrally with the rotation shaft by being supported on the rotation shaft in a non-relatively rotatable manner; a second rotation body that is supported on the rotation shaft in a relatively rotatable manner in a position facing the first rotation body in an axial direction; an electromagnet that brings the first and second rotation bodies into pressure contact to connect the first and second rotation bodies in a manner capable of transmitting a torque by moving one of the first and second rotation bodies as an armature in an axial direction based on an electromagnetic attraction force generated by energization; and a gear portion that is provided on an outer periphery of at least one of the first rotation body or the second rotation body.

### CROSS REFERENCE TO RELATED APPLICATIONS

This application is based on and claims priority under 35 U.S.C. § 119 to Japanese Patent Application 2019-146747, filed on Aug. 8, 2019, the entire contents of which are incorporated herein by reference.

### TECHNICAL FIELD

This disclosure relates to an electromagnetic clutch and an opening and closing body drive device for a vehicle.

### BACKGROUND DISCUSSION

In related arts, for example, an opening and closing body drive device for a vehicle, such as a power slide door device, is provided with an electromagnetic clutch in a driving force transmission path thereof. For example, a door opening and closing device disclosed in JP 2015-40423A (Reference 1) includes an electromagnetic clutch disposed coaxially with a flat motor, and a drum having a rotation shaft parallel to an axis line of the flat motor and the electromagnetic clutch. Further, the opening and closing device meshes a first gear provided on an output shaft of the electromagnetic clutch with a second gear provided on the rotation shaft of the drum to decelerate motor rotation output via the electromagnetic clutch and transmit the motor rotation to the drum. Accordingly, by reducing a size of the device, excellent mountability for a vehicle is ensured.

However, all components in a vehicle have been improving. Also, there is still room for improvement since improvement in mountability is required for the electromagnetic clutch used in the opening and closing body drive device.

Thus, a need exists for an electromagnetic clutch and an opening and closing body drive device for a vehicle which are not susceptible to the drawback mentioned above.

### SUMMARY

An electromagnetic clutch according to an aspect of this disclosure includes a rotation shaft that transmits a drive torque; a first rotation body that rotates integrally with the rotation shaft by being supported on the rotation shaft in a non-relatively rotatable manner; a second rotation body that is supported on the rotation shaft in a relatively rotatable manner in a position facing the first rotation body in an axial direction; an electromagnet that brings the first rotation body and the second rotation body into pressure contact to connect the first rotation body and the second rotation body in a manner capable of transmitting a torque by moving one of the first rotation body and the second rotation body as an armature in an axial direction based on an electromagnetic attraction force generated by energization; and a gear portion that is provided on an outer periphery of at least one of the first rotation body or the second rotation body.

An opening and closing body drive device for a vehicle according to another aspect of this disclosure includes the electromagnetic clutch described above, a motor that generates the drive torque; a drive gear that meshes with the gear portion; a rotation member that rotates integrally with the drive gear; and a drive member that drives an opening and closing body of a vehicle based on rotation of the rotation member by being wound around the rotation member.

### BRIEF DESCRIPTION OF THE DRAWINGS

The foregoing and additional features and characteristics of this disclosure will become more apparent from the following detailed description considered with the reference to the accompanying drawings, wherein:

FIG. 1 is a plan view of a vehicle including a swing door;

FIG. 2 is a perspective view of the swing door;

FIG. 3 is a schematic configuration diagram of an opening and closing drive device provided in the swing door;

FIG. 4 is a perspective view of a deceleration mechanism, an electromagnetic clutch, and a drum constituting the opening and closing drive device;

FIG. 5 is a side view of the deceleration mechanism, the electromagnetic clutch, and the drum constituting the opening and closing drive device;

FIG. 6 is a perspective view showing another example of the electromagnetic clutch and the opening and closing drive device;

FIG. 7 is a side view showing the other example of the electromagnetic clutch and the opening and closing drive device;

FIG. 8 is a side view showing another example of the electromagnetic clutch and the opening and closing drive device;

FIG. 9 is a side view showing another example of the electromagnetic clutch and the opening and closing drive device;

FIG. 10 is a side view showing another example of the electromagnetic clutch and the opening and closing drive device; and

FIG. 11 is a side view showing another example of the electromagnetic clutch and the opening and closing drive device.

### DETAILED DESCRIPTION

Hereinafter, one embodiment in which an opening and closing body drive device for a vehicle is embodied as an opening and closing drive device of a swing door will be described with reference to drawings.

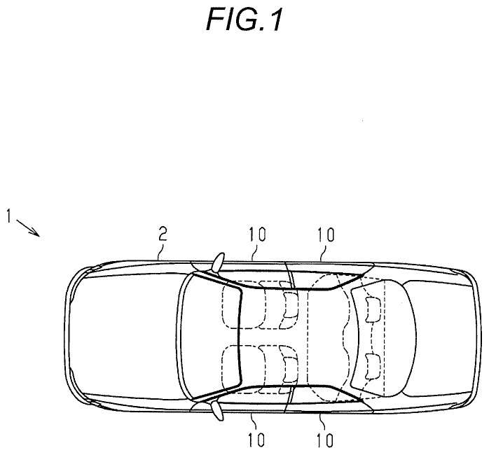

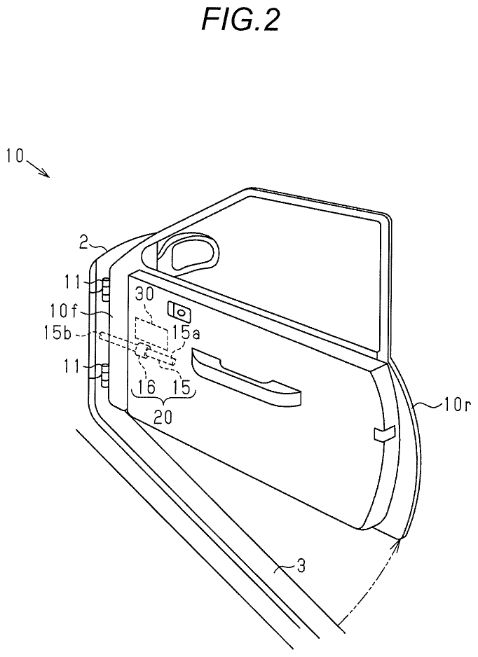

As shown in FIGS. 1 and 2, a vehicle 1 according to the embodiment includes a plurality of swing doors 10 that open and close a door opening portion 3 provided on a side surface of a vehicle body 2. That is, each of the swing doors 10 rotates about a hinge 11 as a pivot. The hinge 11 is provided at a front end portion 10f of each of the swing doors 10. In the vehicle 1 according to the embodiment, each of the swing doors 10 is configured to open and close on a side of each seat provided in an interior of the vehicle 1.

The swing door 10 in the embodiment is provided with an elongated substantially rod-shaped check bar 15 extending from a front end portion 10f side toward a rear end portion 10r side of the swing door 10 in a state in which a base end portion 15b of the check bar 15 is rotatably connected to the vehicle body 2. Further, the swing door 10 is provided with a door side engaging member 16 that slidably engages with the check bar 15 in a state of being fixed to the swing door 10. Still, the door side engaging member 16 includes a shoe (not shown) that slides against a peripheral surface of the check bar 15, and a case that covers an outer side of the shoe. The vehicle 1 according to the embodiment further includes an opening and closing drive device 30 that drives the swing door 10 to open and close based on operation of a door check device 20 constituted by the check bar 15 and the door side engaging member 16.

Specifically, the door check device 20 in the embodiment is in conjunction with opening and closing operation of the swing door 10 and the check bar 15 rotates with the base end portion 15b connected to the vehicle body 2 as a pivot. Based on the rotation of the check bar 15, an engagement position of the door side engaging member 16 moves along a longitudinal direction of the check bar 15.

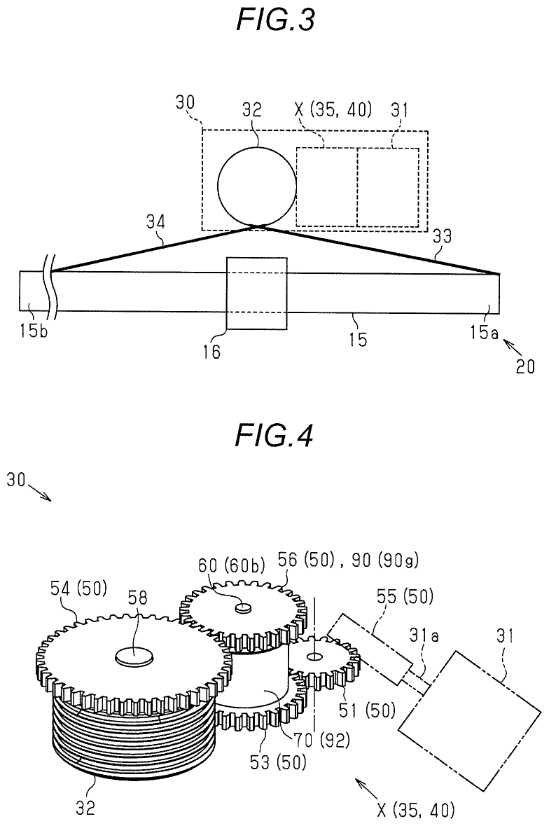

As shown in FIG. 3, the opening and closing drive device 30 according to the embodiment includes a motor 31 serving as a drive source, and a drum 32 that rotates based on a drive torque generated by the motor 31. Further, the opening and closing drive device 30 includes a first drive cable 33 with one end in a state of wound around the drum 32 and other end fixed to a tip end portion 15a of the check bar 15. The opening and closing drive device 30 according to the embodiment includes a second drive cable 34 which is also wound around the drum 32 at one end and is fixed to the check bar 15 in a position closer to the base end portion 15b than the door side engaging member 16 in the longitudinal direction.

That is, in the opening and closing drive device 30 according to the embodiment, the drum 32 winds one of the first drive cable 33 and the second drive cable 34 while rolling out on the other one by the rotation of the drum 32. Accordingly, the opening and closing drive device 30 according to the embodiment drives the swing door 10 to open and close by moving the engagement position of the door side engaging member 16 relative to the check bar 15.

Specifically, by winding the first drive cable 33 onto the drum 32 while rolling out the second drive cable 34 from the drum 32, the engagement position of the door side engaging member 16 relative to the check bar 15 apparently moves to a tip end portion 15a side (right side in FIG. 3) of the check bar 15. Accordingly, the opening and closing drive device 30 according to the embodiment drives the swing door 10 to open.

On the other hand, by winding the second drive cable 34 onto the drum 32 while rolling out the first drive cable 33 from the drum 32, the engagement position of the door side engaging member 16 relative to the check bar 15 apparently moves to the base end portion 15b side (left side in FIG. 3) of the check bar 15. Accordingly, the opening and closing drive device 30 according to the embodiment drives the swing door 10 to close.

In addition, the opening and closing drive device 30 according to the embodiment decelerates the rotation of the motor 31 by a deceleration mechanism 35 and transmits the decelerated rotation to the drum 32. Further, the opening and closing drive device 30 includes an electromagnetic clutch 40 provided in a transmission path X of a drive torque formed by the deceleration mechanism 35. That is, the electromagnetic clutch 40 has a function of connecting and disconnecting the transmission path X of the drive torque by operation. By turning off the electromagnetic clutch 40, the opening and closing drive device 30 according to the embodiment can manually open and close the swing door 10 with a relatively small operating force.

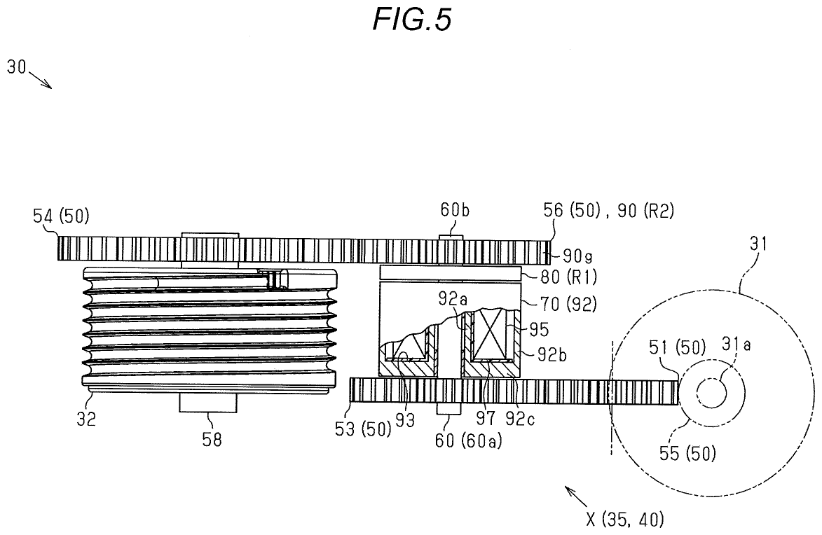

More specifically, as shown in FIGS. 4 and 5, the opening and closing drive device 30 according to the embodiment includes a plurality of gears 50 constituting the deceleration mechanism 35. Specifically, the opening and closing drive device 30 includes an input gear 51 that receives the drive torque of the motor 31, and a first intermediate gear 53 that meshes with the input gear 51. In the opening and closing drive device 30 according to the embodiment, the input gear 51 receives the drive torque of the motor 31 via a worm 55 that rotates integrally with an output shaft 31a of the motor 31. Also, the opening and closing drive device 30 according to the embodiment includes a drive gear 54 that rotates integrally with the drum 32, and a second intermediate gear 56 that meshes with the drive gear 54.

The opening and closing drive device 30 according to the embodiment includes a rotation shaft 60 disposed in parallel with a rotation shaft 58 of the drum 32 and the drive gear 54. In the opening and closing drive device 30 according to the embodiment, the first intermediate gear 53, the second intermediate gear 56, and the electromagnetic clutch 40 are disposed coaxially by sharing the rotation shaft 60.

As shown in FIG. 5, in the opening and closing drive device 30 according to the embodiment, the first intermediate gear 53 is fixed on a first end portion (lower end portion in FIG. 5) 60a of the rotation shaft 60 in a non-relatively rotatable manner. Accordingly, in the opening and closing drive device 30 according to the embodiment, the first intermediate gear 53 rotates integrally with the rotation shaft 60.

The electromagnetic clutch 40 according to the embodiment includes an electromagnet 70 provided closer to a second end portion (upper end portion in FIG. 5) 60b of the rotation shaft 60 than the first intermediate gear 53. Further, the electromagnetic clutch 40 includes a rotor 80 having a substantially disk-shaped outer shape in a position closer to the second end portion 60b (upper side in FIG. 5) of the rotation shaft 60 than the electromagnet 70. The rotor 80 is fixed on the rotation shaft 60 in a manner of being non-relatively rotatable and not relatively movable in the axial direction relative to the rotation shaft 60. Also, the electromagnetic clutch 40 according to the embodiment includes an armature 90 having a substantially disk-shaped outer shape in a position closer to the second end portion 60b of the rotation shaft 60 than the rotor 80. The armature 90 is supported on the rotation shaft 60 in a manner of being relatively rotatable and relatively movable in the axial direction relative to the rotation shaft 60.

Specifically, the electromagnet 70 in the embodiment includes a yoke 92 having an annular outer shape and surrounding a radially outer side of the rotation shaft 60, an annular groove 93 extending over an entire circumference of the yoke 92, and an exciting coil 95 accommodated in the annular groove 93. Specifically, the yoke 92 in the embodiment includes an inner cylinder portion 92a through which the rotation shaft 60 is inserted, an outer cylinder portion 92b that surrounds a radially outer side of the inner cylinder portion 92a, and a bottom wall portion 92c that connects end sides in the axial direction of the inner cylinder portion 92a and the outer cylinder portion 92b. Also, the electromagnet 70 in the embodiment accommodates the exciting coil 95 wound around a bobbin 97 having an annular outer shape in the annular groove 93 formed by the inner cylinder portion 92a, the outer cylinder portion 92b, and the bottom wall portion 92c.

That is, in the electromagnet 70 in the embodiment, the yoke 92 is formed using a magnetic object such as an iron-based metal. The bobbin 97 is formed using a non-magnetic object such as a resin. Accordingly, the electromagnet 70 in the embodiment generates an electromagnetic attraction force acting in the axial direction of the rotation shaft 60 where the electromagnet 70 is provided by energizing the exciting coil 95 in the annular groove 93 provided in the yoke 92.

In the electromagnetic clutch 40 according to the embodiment, the armature 90 is also formed using a magnetic object such as an iron-based metal. The armature 90 is disposed in a position in the axial direction such that the rotor 80 is sandwiched between the electromagnet 70 and the armature 90. Further, the armature 90 in the embodiment includes a gear portion 90g on an outer periphery of the disk shape. Specifically, the gear portion 90g is engraved on the outer periphery of the armature 90. Thus, in the configuration of the opening and closing drive device 30 according to the embodiment, by meshing the gear portion 90g with the drive gear 54 fixed to the rotation shaft 58 integrally with the drum 32, the armature 90 of the electromagnetic clutch 40 functions as the second intermediate gear 56.

That is, in the electromagnetic clutch 40 according to the embodiment, the rotor 80 that rotates integrally with the rotation shaft 60 by being supported on the rotation shaft 60 in a non-relatively rotatable manner forms a first rotation body R1. The armature 90, which is supported on the rotation shaft 60 in a relatively rotatable manner in a position facing the rotor 80 in the axial direction, forms a second rotation body R2. Further, the armature 90 moves in the axial direction in a way of sliding on the rotation shaft 60 based on the electromagnetic attraction force generated by the electromagnet 70 provided in a position in the axial direction such that the rotor 80 is sandwiched between the armature 90 and the electromagnet 70, whereby the armature 90 is brought into pressure contact with the rotor 80. Accordingly, in the electromagnetic clutch 40 according to the embodiment, the rotor 80 and the armature 90 are connected to transmit a torque, so that the armature 90 serving as the second intermediate gear 56 rotates integrally with the rotation shaft 60 that transmits the drive torque of the motor 31.

That is, in the opening and closing drive device 30 according to the embodiment, by turning on the electromagnetic clutch 40 in this manner, the drive torque of the motor 31 transmitted to the rotation shaft 60 via the input gear 51 and the first intermediate gear 53 is transmitted to the drum 32 via the drive gear 54 meshing with the gear portion 90g provided in the armature 90 serving as the second intermediate gear 56. Accordingly, in the configuration of the opening and closing drive device 30 according to the embodiment, by rotating the drum 32, the first drive cable 33 and the second drive cable 34 serving as drive members wound around the drum 32 drive to the swing door 10 open and close in accordance with the rotation direction of the drum 32.

Further, by stopping energizing the electromagnet 70, the connection between the rotor 80 and the armature 90 is released. That is, the armature 90 serving as the second intermediate gear 56 is again brought into a state of being relatively rotatable about the rotation shaft 60. The opening and closing drive device 30 according to the embodiment blocks the transmission path X of the drive torque and allows free rotation of the drum 32 by turning off the electromagnetic clutch 40 in this manner.

In the opening and closing drive device 30 according to the embodiment, the gear portion 90g provided on the armature 90 and the drive gear 54 meshed with the gear portion 90g are spur gears. Accordingly, in the opening and closing drive device 30 according to the embodiment, the meshing state between the gear portion 90g and the drive gear 54 is maintained even when the armature 90 moves in the axial direction.

Next, effects of the embodiment will be described.

(1) The electromagnetic clutch 40 includes the rotation shaft 60 that transmits a drive torque, the rotor 80 serving as the first rotation body R1 that rotates integrally with the rotation shaft 60 by being supported on the rotation shaft 60 in a non-relatively rotatable manner, and the armature 90 serving as the second rotation body R2 that is supported on the rotation shaft 60 in a relatively rotatable manner in a position facing the rotor 80 in the axial direction. The electromagnetic clutch 40 further includes the electromagnet 70 that brings the armature 90 and the rotor 80 into pressure contact and connects the armature 90 and the rotor 80 to transmit a torque by moving the armature 90 in the axial direction based on an electromagnetic attraction force generated by energization. Further, the gear portion 90g is provided on the outer periphery of the armature 90. The electromagnetic clutch 40 outputs the drive torque transmitted to the rotation shaft 60 from the gear portion 90g provided in the armature 90.

According to the above configuration, it is possible to shorten a dimension in the axial direction by reducing a gear member that outputs the drive torque transmitted to the rotation shaft 60. Further, the gear portion 90g can be used in the deceleration mechanism 35. Accordingly, by reducing the size, it is possible to ensure excellent mountability.

(2) The gear portion 90g is engraved on the outer periphery of the armature 90.

According to the above configuration, the number of components can be further reduced. Accordingly, it is possible to reduce a manufacturing cost and facilitate assembly work.

(3) The opening and closing drive device 30 includes the electromagnetic clutch 40, the motor 31 that generates the drive torque, the drive gear 54 that meshes with the gear portion 90g provided on the armature 90 of the electromagnetic clutch 40, and the drum 32 serving as a rotation member that rotates integrally with the drive gear 54. Further, the opening and closing drive device 30 includes the first drive cable 33 and the second drive cable 34 serving as drive members wound around the drum 32. Then, based on the rotation of the drum 32, the opening and closing drive device 30 drives the swing door 10 serving as an opening and closing body provided in the vehicle 1 to open and close by winding one of the first drive cable 33 and the second drive cable 34 onto the drum 32 while rolling out the other one from the drum 32.

According to the above configuration, it is possible to improve mountability of the vehicle 1. Accordingly, swing doors 10 of various sizes can be opened and closed by motor driving.

The above-described embodiment can be modified and implemented as follows. The above-described embodiment and the following modifications can be implemented in combination with each other as long as they do not have a technical contradiction.
In the above embodiment, the gear portion 90g provided on the outer periphery of the armature 90 constituting the electromagnetic clutch 40 is meshed with the drive gear 54 that rotates integrally with the drum 32. Accordingly, the drive torque transmitted to the rotation shaft 60 is output from the gear portion 90g of the armature 90.

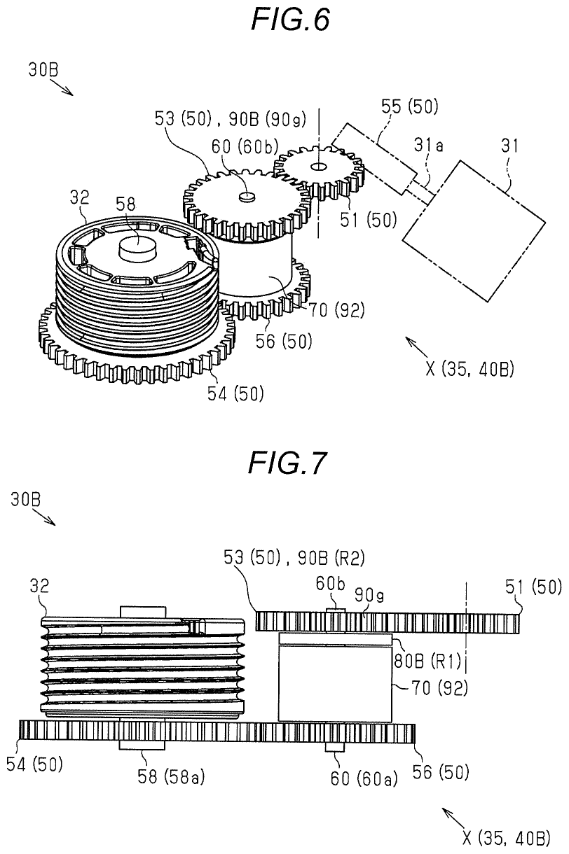

However, the disclosure is not limited thereto, for example, the drive torque may be input to the gear portion 90g of an armature 90B as in an opening and closing drive device 30B shown in FIGS. 6 and 7. Accordingly, it is possible to reduce a gear member for inputting the drive torque to the rotation shaft 60.

Specifically, in the opening and closing drive device 30B, the drive gear 54 that rotates integrally with the drum 32 is provided to a first end portion 58a of the rotation shaft 58, and the second intermediate gear 56 that meshes with the drive gear 54 is provided to the first end portion 60a of the rotation shaft 60. The electromagnet 70 is provided closer to the second end portion 60b of the rotation shaft 60 than the second intermediate gear 56. Further, in the opening and closing drive device 30B, the input gear 51 meshes with the gear portion 90g of the armature 90B provided on the second end portion 60b of the rotation shaft 60, whereby the armature 90B functions as the first intermediate gear 53. Accordingly, the electromagnetic clutch 40B in the opening and closing drive device 30B connects the armature 90B and a rotor 80B to each other to transmit a torque based on the electromagnetic attraction force generated by the electromagnet 70, so that the armature 90B serves as an input unit and the driving force of the motor 31 is transmitted to the rotation shaft 60.
In the above embodiment, the rotor 80, which rotates integrally with the rotation shaft 60 by being supported on the rotation shaft 60 in a non-relatively rotatable manner, constitutes the first rotation body R1, and the armature 90 supported on the rotation shaft 60 in a relatively rotatable manner in a position facing the rotor 80 in the axial direction constitutes the second rotation body R2. The gear portion 90g is provided on the outer periphery of the armature 90.

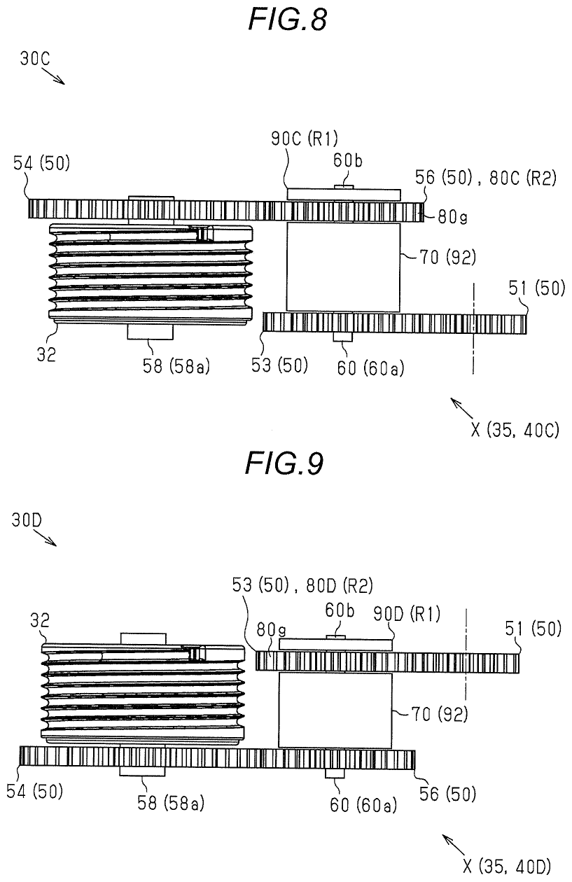

However, the disclosure is not limited thereto, for example, as in an electromagnetic clutch 40C in an opening and closing drive device 30C shown in FIG. 8, an armature 90C is supported on the rotation shaft 60 in a non-relatively rotatable manner, so that the armature 90C serves as the first rotation body R1 that rotates integrally with the rotation shaft 60. A rotor 80C serves as the second rotation body R2 supported on the rotation shaft 60 in a relatively rotatable manner in a position facing the armature 90C serving as the first rotation body R1 in the axial direction. A gear portion 80g may be provided on an outer periphery of the rotor 80C.

Specifically, in the electromagnetic clutch 40C, the armature 90C is supported on the rotation shaft 60 in a state in which the armature 90C is relatively movable in the axial direction, and the rotor 80C is supported on the rotation shaft 60 in a state in which the rotor 80C is not relatively movable in the axial direction. That is, in the electromagnetic clutch 40C, the armature 90C moves in the axial direction in a way of sliding on the rotation shaft 60 based on the electromagnetic attraction force generated by the electromagnet 70. Accordingly, the armature 90C is brought into pressure contact with the rotor 80C, so that the armature 90C and the rotor 80C are connected to each other to transmit a torque.

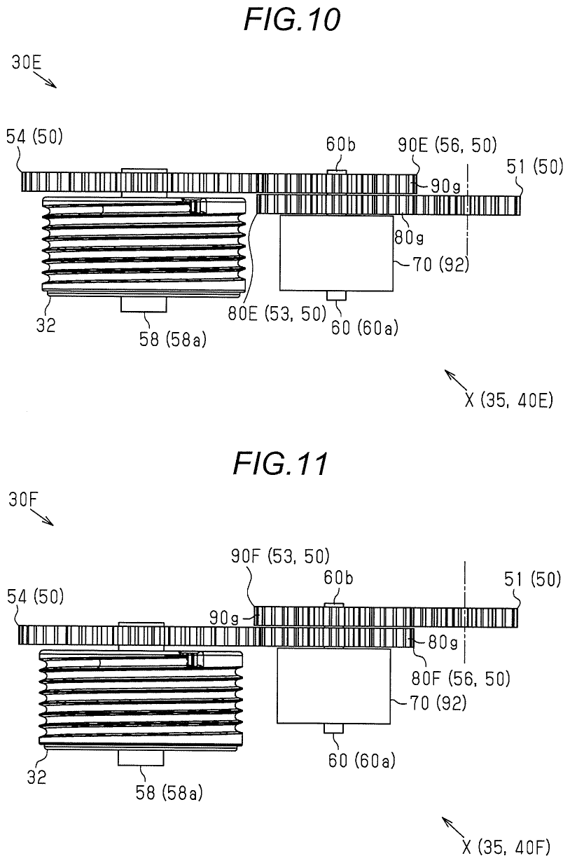

Further, in the opening and closing drive device 30C, the drive gear 54 that rotates integrally with the drum 32 meshes with the gear portion 80g of the rotor 80C. That is, the electromagnetic clutch 40C in the opening and closing drive device 30C outputs the driving force transmitted from the rotor 80C to the rotation shaft 60 by connecting the armature 90C and the rotor 80C to transmit a torque based on the electromagnetic attraction force generated by the electromagnet 70. By adopting such a configuration, it is possible to reduce the gear member for outputting the drive torque transmitted to the rotation shaft 60.
In addition, in an opening and closing drive device 30D shown in FIG. 9, the input gear 51 meshes with the gear portion 80g provided on an outer periphery of a rotor 80D serving as the second rotation body R2. That is, accordingly, an electromagnetic clutch 40D in the opening and closing drive device 30D connects the armature 90D and the rotor 80D to each other to transmit a torque based on the electromagnetic attraction force generated by the electromagnet 70, so that the rotor 80D serves as the input unit and the driving force is transmitted to the rotation shaft 60. By adopting such a configuration, it is possible to reduce the gear member for inputting the drive torque to the rotation shaft 60.
Further, as in an electromagnetic clutch 40E in an opening and closing drive device 30E shown in FIG. 10, the gear portion 90g is provided on an outer periphery of an armature 90E, and the gear portion 80g is provided on an outer periphery of a rotor 80E. Further, the input gear 51 may be meshed with the gear portion 80g of the rotor 80E and the drive gear 54 that rotates integrally with the drum 32 may be meshed with the gear portion 90g of the armature 90E.
Further, as an electromagnetic clutch 40F in an opening and closing drive device 30F shown in FIG. 11, the input gear 51 may be meshed with the gear portion 90g of an armature 90F, and the drive gear 54 that rotates integrally with the drum 32 may be meshed with the gear portion 80g of a rotor 80F.

That is, as the electromagnetic clutches 40E and 40F, the gear portion 90g is provided on outer peripheries of the armature 90E and the armature 90F, and the gear portion 80g is provided on outer peripheries of the rotors 80E and 80F, so that a gear member for inputting a drive torque to the rotation shaft 60 and a gear member for outputting a drive torque transmitted to the rotation shaft 60 can be reduced. Further, the gear portions 80g and 90g can be used for the deceleration mechanism 35. Accordingly, it is possible to further reduce the size.

In this case, the armatures 90E and 90F may serve as the first rotation body R1 and the rotors 80E and 80F as the second rotation body R2. Also, the armatures 90E and 90F may serve as the second rotation body R2 and the rotors 80E and 80F as the first rotation body R1.
In the embodiment, the armature 90 is supported on the rotation shaft 60 in a state in which the armature 90 is relatively movable in the axial direction, and the rotor 80 is supported on the rotation shaft 60 in a state in which the rotor 80 is not relatively movable in the axial direction. Accordingly, the armature 90 is brought into pressure contact with the rotor 80 by moving the armature 90 in the axial direction in a way of sliding on the rotation shaft 60 based on the electromagnetic attraction force generated by the electromagnet 70. However, the disclosure is not limited thereto, the armature 90 may be supported on the rotation shaft 60 in a state in which the armature 90 is not relatively movable in the axial direction, and the rotor 80 may be supported on the rotation shaft 60 in a state in which the rotor 80 is relatively movable in the axial direction. Further, the armature 90 moves in the axial direction integrally with the rotation shaft 60 based on the electromagnetic attraction force generated by the electromagnet 70. An absolute position of the rotor 80 is held also by the movement in the axial direction of the rotation shaft 60, so that the armature 90 may be brought into pressure contact with the rotor 80.
In the above embodiment, although the gear portion 90g is engraved on the outer periphery of the armature 90, the gear portion 90g may be formed by attaching an annular member having gear teeth on the outer periphery to the outer periphery of the armature 90.
In the above embodiment, although the drive torque of the motor 31 is input to the input gear 51 via the worm 55 that rotates integrally with the output shaft 31a of the motor 31, the input gear 51 may rotate integrally with the output shaft 31a of the motor 31, for example, the input gear 51 itself may serve as the worm 55.
In the above embodiment, although the electromagnetic clutch 40 in the opening and closing drive device 30 of the swing door 10 is specified, the disclosure may be applied to, for example, an opening and closing drive device of a vehicle door having other types such as a slide door. Further, the disclosure may be applied to a drive device of an opening and closing body other than a door, for example, a sunroof. Also, the disclosure is not limited to such an opening and closing body drive device for a vehicle, and may be applied to an actuator device used in an application other than a vehicle.
In the above embodiment, the opening and closing drive device 30 serving as the opening and closing body drive device for a vehicle includes the drum 32 serving as a rotation member that rotates based on the drive torque of the motor 31 via the electromagnetic clutch 40, and the first drive cable 33 and the second drive cable 34 serving as drive members wound around the drum 32. However, the disclosure is not limited thereto, and the opening and closing body of the vehicle may be driven with a pulley as a rotation member and a belt as a drive member.

Next, technical ideas that can be understood from the above embodiment and modifications will be described.

An electromagnetic clutch according to an aspect of this disclosure includes a rotation shaft that transmits a drive torque; a first rotation body that rotates integrally with the rotation shaft by being supported on the rotation shaft in a non-relatively rotatable manner; a second rotation body that is supported on the rotation shaft in a relatively rotatable manner in a position facing the first rotation body in an axial direction; an electromagnet that brings the first rotation body and the second rotation body into pressure contact to connect the first rotation body and the second rotation body in a manner capable of transmitting a torque by moving one of the first rotation body and the second rotation body as an armature in an axial direction based on an electromagnetic attraction force generated by energization; and a gear portion that is provided on an outer periphery of at least one of the first rotation body or the second rotation body.

According to the above configuration, by omitting at least one of a gear member for inputting a drive torque to the rotation shaft and a gear member for outputting the drive torque transmitted to the rotation shaft, a dimension in an axial direction of the electromagnetic clutch can be shortened. Further, the gear portion of the electromagnetic clutch can be used as a deceleration mechanism. Accordingly, by reducing the size, it is possible to ensure excellent mountability.

In the electromagnetic clutch, it is preferable that the gear portion that receives the drive torque is provided on one of the first rotation body and the second rotation body.

According to the above configuration, it is possible to reduce the gear member for inputting a drive torque to the rotation shaft and to reduce the size.

In the electromagnetic clutch, it is preferable that the gear portion that outputs the drive torque is provided on one of the first rotation body and the second rotation body.

According to the above configuration, it is possible to reduce the gear member for outputting the drive torque transmitted to the rotation shaft and to reduce the size.

In the electromagnetic clutch, it is preferable that the gear portion is engraved on the outer periphery.

According to the above configuration, the number of components can be further reduced. Accordingly, it is possible to reduce the manufacturing cost and facilitate assembly work.

An opening and closing body drive device for a vehicle according to another aspect of this disclosure includes the electromagnetic clutch described above, a motor that generates the drive torque; a drive gear that meshes with the gear portion; a rotation member that rotates integrally with the drive gear; and a drive member that drives an opening and closing body of a vehicle based on rotation of the rotation member by being wound around the rotation member.

According to the above configuration, it is possible to improve mountability of the vehicle. Accordingly, various opening and closing bodies provided in the vehicle can be opened and closed by motor driving.

An actuator device according to still another aspect of this disclosure includes any of the electromagnetic clutches and a motor that generates the drive torque.

According to the disclosure, excellent mountability can be ensured.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

What is claimed is:

1. An electromagnetic clutch comprising:
a rotation shaft that transmits a drive torque;
a first rotation body that rotates integrally with the rotation shaft by being supported on the rotation shaft in a non-relatively rotatable manner;
a second rotation body that is supported on the rotation shaft in a relatively rotatable manner in a position facing the first rotation body in an axial direction;
an electromagnet that brings the first rotation body and the second rotation body into pressure contact to connect the first rotation body and the second rotation body in a manner capable of transmitting a torque by moving one of the first rotation body and the second rotation body as an armature in an axial direction based on an electromagnetic attraction force generated by energization; and
a gear portion that is provided on an outer periphery of at least one of the first rotation body or the second rotation body.

2. The electromagnetic clutch according to claim 1, wherein
the gear portion that receives the drive torque is provided on one of the first rotation body and the second rotation body.

3. The electromagnetic clutch according to claim 1, wherein
the gear portion that outputs the drive torque is provided on one of the first rotation body and the second rotation body.

4. An opening and closing body drive device for a vehicle, the opening and closing body drive device comprising:
the electromagnetic clutch according to claim 1;
a motor that generates the drive torque;
a drive gear that meshes with the gear portion;
a rotation member that rotates integrally with the drive gear; and
a drive member that drives an opening and closing body of a vehicle based on rotation of the rotation member by being wound around the rotation member.
